(19) United States
(12) Patent Application Publication
(10) Pub. No.: US 2022/0182879 A1
(43) Pub. Date: Jun. 9, 2022

(54) NR CBG ENHANCEMENTS AND OVERHEAD REDUCTION

(71) Applicant: Fraunhofer-Gesellschaft zur Foerderung der angewandten Forschung e.V., Munich (DE)

(72) Inventors: Thomas FEHRENBACH, Berlin (DE); Baris GÖKTEPE, Berlin (DE); Cornelius HELLGE, Berlin (DE); Thomas WIRTH, Berlin (DE); Thomas SCHIERL, Berlin (DE); Khaled Shawky HASSAN HUSSEIN, Erlangen (DE); Martin LEYH, Erlangen (DE); Thomas HEYN, Erlangen (DE); Bernhard NIEMANN, Erlangen (DE); Julian POPP, Erlangen (DE); Nithin SRINIVASAN, Berlin (DE)

(21) Appl. No.: 17/679,695

(22) Filed: Feb. 24, 2022

Related U.S. Application Data
(63) Continuation of application No. PCT/EP2020/074010, filed on Aug. 27, 2020.

(30) Foreign Application Priority Data
Aug. 30, 2019 (EP) 19194755.5

(51) Int. Cl. H04W 28/06; H04L 1/16; H04W 72/04; H04W 74/08; H04W 16/14

(52) U.S. Cl. CPC H04W 28/06; H04L 1/1607; H04W 16/14; H04W 74/0808; H04W 72/0453

(57) ABSTRACT

An apparatus for a wireless communication system uses a plurality of frequency bands for a communication with one or more network entities. The apparatus receives a transport block, TB, which is split into a plurality of code block groups, CBGs, comprising one or more code blocks, CBs, confined to one of the plurality of frequency bands. The apparatus provides or predicts a feedback for each CBG indicating one or more of a successful receipt, a non-successful receipt, no need for redundancy and a need for some redundancy. The apparatus compresses the feedbacks for each CBG into a compressed feedback based on an interference pattern on one or more of the frequency bands which is detectable at the apparatus and the transmitter or the one or more network entities, e.g. Listen-before-Talk, LBT, failure, and to transmit to the one or more of the network entities the compressed feedback.

### CROSS-REFERENCES TO RELATED APPLICATIONS

This application is a continuation of copending International Application No. PCT/EP2020/074010, filed Aug. 27, 2020, which is incorporated herein by reference in its entirety, and additionally claims priority from European Application No. EP 19 194 755.5, filed Aug. 30, 2019, which is incorporated herein by reference in its entirety.

The present application relates to the field of wireless communication systems or networks, more specifically to enhancements in the communication among network entities of the communication network when performing a communication using a plurality of frequency bands, some or all of which may include frequency bands in the unlicensed spectrum. Embodiments of the present invention concern enhancements in the feedback mechanism for reporting successful/non-successful transmissions of data or no need for redundancy for the data or a need for some redundancy for the data or an amount of additional redundancy needed for the data in a multi-band operation, for example, improvements for the hybrid automatic repeat request, HARQ, feedback.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard, or the 5G or NR, New Radio, standard, or the NU-U, New Radio Unlicensed, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

It is noted that the information in the above section is only for enhancing the understanding of the background of the invention and therefore it may contain information that does not form conventional technology that is already known to a person of ordinary skill in the art.

Starting from conventional technology as described above, there may be a need for improvements of the feedback mechanism used in a wireless communication among entities of wireless communication networks using multiple frequency bands.

### SUMMARY

An embodiment may have an apparatus for a wireless communication system, wherein the apparatus is to use a plurality of frequency bands for a communication with one or more network entities, e.g., one or more user devices or one or more base stations, in the wireless communication system, wherein the apparatus is to receive from a transmitter or the one or more network entities a transport block, TB, the TB being split into a plurality of code block groups, CBGs, each CBG including one or more code blocks, CBs, and being confined to one of the plurality of frequency bands, wherein the apparatus is to provide or predict a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback, and wherein the apparatus is to compress the feedbacks and/or the predicted feedbacks for each of the CBGs into a compressed feedback based on an interference pattern on one or more of the frequency bands which is detectable at the apparatus and the transmitter or the one or more network entities, e.g. Listen-before-Talk, LBT, failure, and to transmit to the one or more of the network entities the compressed feedback.

Another embodiment may have an apparatus for a wireless communication system, wherein the apparatus is to use a plurality of frequency bands for a communication with one or more network entities, e.g., one or more user devices or base stations, in the wireless communication system, wherein the apparatus is to receive a transport block, TB, the TB being split into a plurality of code block groups, CBG, each CBG including one or more code blocks, CBs, and being confined to one of the plurality of frequency bands, and one or more of the plurality of CBGs spanning the TB duration, wherein the apparatus is to provide a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and wherein, in case of a failure of one or more of the frequency bands, the apparatus is to reduce the feedback or the predicted feedbacks, e.g., a number of bits for the feedback or the predicted feedback, according to the failed frequency bands.

Another embodiment may have an apparatus for a wireless communication system, wherein the apparatus is to use a plurality of frequency bands for a communication with one or more network entities, e.g., one or more user devices or one or more base stations, in the wireless communication system, wherein the apparatus is to receive a transport block, TB, the TB being split into a plurality of code block groups, CBGs, each CBG including one or more code blocks, CBs, and being confined to one of the plurality of frequency bands, wherein the apparatus is to provide or predict a regular feedback for each of the CBGs indicating a successful and/or a non-successful receipt of the CBG, e.g., a hybrid automatic repeat request, HARQ, feedback, and wherein, in case an amount of interference on one or more of the frequency bands which is detectable at the receiver, e.g. an interference due to a hidden node problem, exceeds a certain threshold, the apparatus is to transmit an early feedback for one or more CBGs ahead of any regular feedback, the early feedback indicating for the one or more CBGs that a CBG or parts of a CBG are not received correctly or are predicted to be not decodable.

Another embodiment may have an apparatus for a wireless communication system, wherein the apparatus is to use a plurality of frequency bands for a communication with one or more network entities, e.g., one or more user devices or one or more base stations, in the wireless communication system, wherein the apparatus is to transmit to a receiver a transport block, TB, the TB being split into a plurality of code block groups, CBGs, each CBG including one or more code blocks, CBs, and being confined to one of the plurality of frequency bands, wherein the apparatus is to receive from the receiver: a regular feedback or a regular predicted feedback for each of the CBGs indicating a successful and/or a non-successful receipt of the CBG, e.g., a hybrid automatic repeat request, HARQ, feedback, and an early feedback ahead of any regular feedback for one or more CBGs on one or more of the frequency bands experiencing an amount of interference, exceeding a certain threshold, and wherein, responsive to the early feedback, the apparatus is to transmit to the receiver a retransmission for the one or more CBGs on one or more frequency bands which are not affected by the interference.

Another embodiment may have a wireless communication system, including one or more user devices and one or more base station, wherein one or more of the user devices and/or one or more of the base stations include an inventive apparatus.

According to an embodiment, a method for providing feedback in a wireless communication system may have the steps of: receiving, by a receiver, from one or more network entities, e.g., one or more user devices or one or more base stations, in the wireless communication system, a transport block, TB, using a plurality of frequency bands, the TB being split into a plurality of code block groups, CBGs, each CBG including one or more code blocks, CBs, and being confined to one of the plurality of frequency bands, providing or predicting a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback, compressing the feedbacks and/or the predicted feedbacks for each of the CBGs into a compressed feedback based on an interference pattern on one or more of the frequency bands which is detectable at the receiver and the one or more network entities, e.g. Listen-before-Talk, LBT, failure, and transmitting to one or more of the network entities the compressed feedback.

According to an embodiment, a method for providing feedback in a wireless communication system may have the steps of: receiving, by a receiver, a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration, providing a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and in case of a failure of one or more of the frequency bands, reducing the feedback or the predicted feedbacks, e.g., a number of bits for the feedback or the predicted feedback, according to the failed frequency bands.

According to an embodiment, a method for providing feedback in a wireless communication system may have the steps of: receiving, by a receiver, a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration, providing or predicting a regular feedback for each of the CBGs indicating a successful and/or a non-successful receipt of the CBG, e.g., a hybrid automatic repeat request, HARQ, feedback, and in case an amount of interference on one or more of the frequency bands which is detectable at the receiver, e.g. an interference due to a hidden node problem, exceeds a certain threshold, transmitting an early feedback for one or more CBGs ahead of any regular feedback, the early feedback indicating for the one or more CBGs that a CBG or parts of a CBG are not received correctly or are predicted to be not decodable.

According to an embodiment, a method for providing feedback in a wireless communication system may have the steps of: transmitting to a receiver a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration, receiving from the receiver a regular feedback or a regular predicted feedback for each of the CBGs indicating a successful and/or a non-successful receipt of the CBG, e.g., a hybrid automatic repeat request, HARQ, feedback, or an early feedback ahead of any regular feedback for one or more CBGs on one or more of the frequency bands experiencing an amount of interference, exceeding a certain threshold, and responsive to the early feedback, transmitting to the receiver a retransmission for the one or more CBGs on one or more frequency bands which are not affected by the interference.

An embodiment may have a non-transitory digital storage medium having a computer program stored thereon to perform an inventive method for providing feedback in a wireless communication system, when said computer program is run by a computer.

### BRIEF DESCRIPTION OF THE DRAWINGS

Embodiments of the present invention will be detailed subsequently referring to the appended drawings, in which:

FIG. 1 shows a schematic representation of an example of a wireless communication system;

FIG. 2 illustrates an example of a TB confining the CBGs to the respective subbands and illustrates schematically the time/frequency resources to be used for a transmission from the transmitter to the receiver using four subbands and multiple CBGs per subband;

FIG. 3 is a schematic representation of a wireless communication system including a transmitter, like a base station, and one or more receivers, like user devices, UEs;

FIG. 4 illustrates an example of a TB confining the CBGs to the respective subbands and illustrates schematically the time/frequency resources to be used for a transmission from the transmitter to the receiver using three subbands and one CBGs per subband;

FIG. 5 illustrates an embodiment of the present invention applying a lossy compression on the basis of a subband based feedback;

FIG. 6 illustrates another embodiment of the present invention illustrating a failed subband;

FIG. 7 illustrates an embodiment of the present invention for a transmitter initiated COT including multiple subbands and employing an early feedback; and

FIG. 8 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

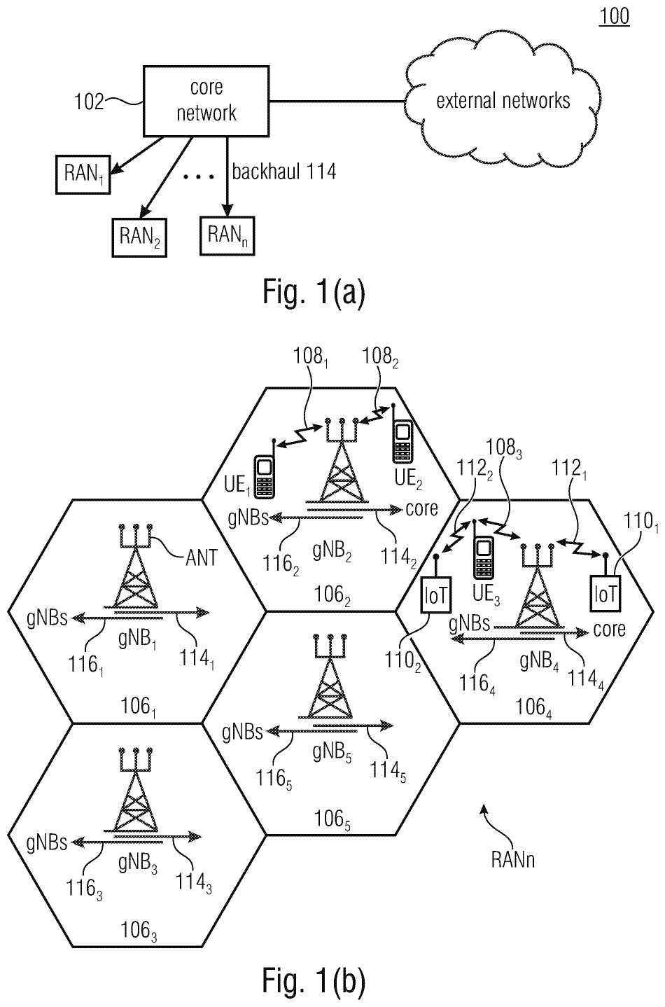

In mobile communication systems or networks, like those described above with reference to FIG. 1, for example in a LTE or 5G/NR network, the respective entities may communicate using one of more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier, a bandwidth part, BWP, a subband, and the like.

When using a single frequency band, the communication may be referred to as a single-band operation, e.g., a UE transmits/receives radio signals to/from another network entity on frequencies being within the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum.

5G New Radio (NR) may support an operation in the unlicensed spectrum so that a multi-band operation may include frequency bands in the unlicensed spectrum bands. This may be referred to as NR-based access to unlicensed spectrum, NR-U, and the frequency bands may be referred to as subbands. The unlicensed spectrum may include bands with a potential IEEE 802.11 coexistence, such as the 5 GHz and the 6 GHz bands. NR-U may support bandwidths that are an integer multiple of 20 MHz, for example due to regulatory requirements. The splitting into the subbands is performed so as to minimize interference with coexisting systems, like IEE 802.11 systems, which may operate in one or more of the same bands with the same nominal bandwidth channels, like 20 MHz channels. Other examples of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands a channel access procedure is to be performed separately per subband, e.g., Listen-before-talk, LBT, or a request to send/clear to send mechanism, RTS/CTS mechanism. This may lead to a situation in which one or more of the subbands are busy or occupied due to an interference, for example, from other communication systems coexisting on the same band, like other public land mobile networks, PLMNs or systems operating in accordance with the IEEE 802.11 specification. In such a situation, the transmitter, either the transmitting gNB or the transmitting UE, is only allowed to transmit on the subbands which are detected to be not busy, also referred to as subbands being free or non-occupied, as is determined by the LBT algorithm. For example for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy or non-won subbands.

For example, the 5G New Radio (NR) technology supports operation in unlicensed bands through a technology referred to as NR-based access to unlicensed spectrum (NR-U). The unlicensed spectrum may include bands, e.g., with potential IEEE 802.11 coexistence, such as the 5 GHz and the 6 GHz bands. NR-U may support bandwidths that are an integer multiple of 20 MHz, for example due to regulatory requirements. Each of the 20 MHz bandwidth channels is designed as a subband, and the splitting into the subbands is performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, unlicensed subbands may be used, for example, the 24 GHz band or the 60 GHz band. Examples of such unlicensed subbands include the industrial, scientific and medical, ISM, radio bands reserved internationally for the use of radio frequency energy for industrial, scientific and medical purposes other than telecommunications.

In general, during a wideband operation using unlicensed subbands, for example a transmission spanning more than 20 MHz in the 5 GHz operational unlicensed band, the transmitter, like the gNB or the UE perform LBT separately on each subband, and once the LBT results are available for each subband, the devices, for example, the gNB in the downlink, DL, or the UE in the uplink, UL, are allowed to only transmit on those subbands which are determined to be free or unoccupied, i.e., to transmit on the won subband. For example, in the 5 GHz unlicensed band, the number of 20 MHz subbands used for a wideband operation may be four, so that the overall bandwidth is 80 MHz, however, the number of actually used subbands may differ.

When considering, for example, a NR unlicensed operation, NR-U, i.e., a multi-band communication using frequency bands or subbands in the unlicensed spectrum, a UE or a gNB may perform LBT to capture the channel for the channel occupancy time, COT. A COT may also be shared with other devices, for example, a UE may share a gNB initiated COT, and the UE may use the gNB initiated COT after a so-called switching gap. In case the gap exceeds a certain duration, for example, 16 μs, the other device may perform LBT, either CAT-2 or CAT-4, dependent on the duration of the gap. In a wideband operation, a UE or a gNB are supposed to perform LBT for each and every subband, and the total amount of subbands may comprise a complete bandwidth part, BWP.

When transmitting in a multi-band or wideband operation, a transport block, TB, is sent out by a transmitter. For example in case of a communication between a base station and a user device, the transmission may be a downlink transmission from the gNB to the UE or an uplink transmission from the UE to the gNB. In case of sidelink communications, the transmitter may be a UE for transmitting the transport block to a receiving UE over the sidelink. The receiver, the UE or the gNB, receives the TB and is to decode the data. A feedback mechanism, like the HARQ mechanism is implemented. The feedback mechanism may indicate or signal to the transmitter a successful or a non-successful transmission of the data, for example by sending an acknowledgement message, ACK, or a non-acknowledgement message, NACK. The feedback mechanism may indicate or signal to the transmitter that there is no need for redundancy for the data or that there is a need for some redundancy for the data. The feedback may also indicate of signal an amount of additional redundancy needed for the data. Responsive to the feedback, the transmitter, in case of a NACK, may perform a retransmission. For example, the retransmission may contain the same information, for example the same data and the same parity bits to allow chase combining at the receiver. The retransmission may also include incremental redundancy.

The TB may be split into a plurality of code block groups, CBGs, and the retransmission mechanism is to indicate the ACK/NACK and is to retransmit the data in the unit of CBG. A CBG may include one or more code blocks, CBs. Thus, when splitting the TB into multiple CBGs, a multiple code block group based HARQ may be used. When considering a multiband operation, the CBGs are confined to a respective frequency band or subband, and one or more CBGs may share the TB duration or the slot duration in a time division multiplex, TDMed, fashion.

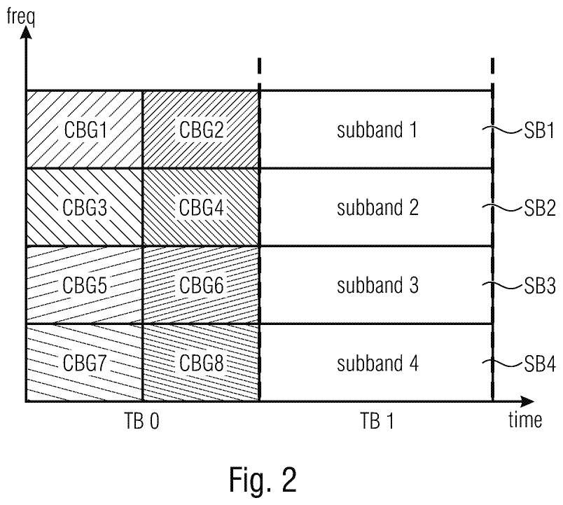

FIG. 2 illustrates an example of a TB confining the CBGs to the respective subbands and illustrates schematically the time/frequency resources to be used for a transmission from the transmitter to the receiver using four subbands SB1 to SB4, for example frequency bands in the unlicensed spectrum. When operating in the unlicensed spectrum, as mentioned above, prior to transmitting on one of the subbands, the transmitter needs to perform a clear channel assessment mechanism, CCA mechanism, which may be the above-mentioned LBT, as is schematically indicated in FIG. 2 by the CCAs associated with each of the subbands SB1 to SB4. Further two transport blocks TB0 and TB1 are illustrated, each of which may span one slot of a radio frame of the wireless communication system. It is assumed that the transport block TB0 is split into eight CBGs, namely CBG1 to CBG8. Each CBG is confined to one subband. For example, CBG1 is confined to SB1, CBG2 is confined to SB1 as well, while CBG3 is confined to SB2, and so on. The CBGs share the slot duration or TB duration of TB0 in a TDMed manner. CBG1 and CBG2, CBG3 and CBG4, CBG5 and CBG6, and CBG7 and CBG8 share the TB duration.

When considering a CBG transmission for a wideband operation in the NR unlicensed spectrum, and when considering two or more subbands, for example each having a 20 MHz bandwidth, in case of a downlink, DL, the gNB may perform a clear channel assessment, CCA, using, for example, listen before talk, LBT. This may be performed both for a load based event, LBE, or for a frame based event, FBE. Once the CCA identifies a free channel, i.e., a channel including all or some of the subbands, the gNB performs the transmission of the TB which is split into the multiple code block groups. In case the UE receives each CBG correctly, for each CBG an ACK feedback is transmitted so as to acknowledge the correct receipt to the gNB. On the other hand, in case the UE detects one or more failing CBGs, even if the LBT was successful for the gNB, the UE needs to feedback to the gNB the respective ACKs/NACKs associated with the correctly received CBGs and associated with the failed CBGs.

In case of an uplink transmission, this transmission may be inside the gNB COT or may be outside the gNB COT. In case of the uplink transmission being inside the gNB COT, the gNB may perform a clear channel assessment, CCA, using, for example, LBT, and grants are distributed to one or more UEs to perform the uplink, and the UE is requested to perform an LBT before the uplink transmission is performed in case the switch gap exceeds a certain period, like 16 μs. In case the uplink transmission is outside the gNB COT, the UE may initiate the COT by performing a CCA for the uplink considering, for example, a dynamic grants or configured grants. In case of a wideband operation as explained with reference to FIG. 2, the UE or the gNB or both the UE and the gNB may perform the subband clear channel assessments for determining the subbands available or being clear for the uplink. The UE may perform an uplink transmission of a TB that is split into the multiple code block groups, and in case the gNB receives all CBGs correctly, all CBGs are acknowledged, i.e., for each CGB an ACK feedback is sent to the UE. Otherwise, in case the gNB detects one or more failing CBGs, the gNB provides the ACK/NACK feedbacks for each of the CBGs to inform the UE which of the CBGs was correctly received and which was not correctly received.

It is noted that the above-described mechanisms regarding the downlink and uplink transmission may equally apply for sidelink communications between two network entities, like two user devices, and the transmission corresponding to the DL transmission is the transmission from the sending UE to the receiving UE, and the transmission corresponding to the UL transmission is the transmission from the receiving UE to the sending UE.

When considering the above-described scenarios of a data transmission in a multi-band operation including a feedback mechanism, one may see that the amount of feedback scales with the number of CBGs into which the TB is split. When considering FIG. 2 and the eight CBGs, for each CBG at least one bit may be used for signaling an ACK, e.g., a “1”, or a NACK, e.g., “0”. In other words, the ACK/NACK transmission and the retransmission of data is to be performed per CBG which, as a consequence, increases the signaling overhead for the signaling of the feedback, like the ACK/NACK from the receiver to the transmitter. Further, the feedback is provided only once the TB has been received at the receiver, so that, for certain services that may use a high reliability and low latency, the feedback may not be received within a predefined time period to allow for fulfilling certain service requirements, i.e., the transmission of the feedback may be too late, for example in case of ultra-reliable low latency communications, URLLC.

The present invention provides improvements and enhancements in the wireless communication system addressing the above described problems. The wireless communication system may use one or more subbands, also referred to as channels or frequency bands of a NR carrier, wherein a frequency band includes a start frequency, an end frequency and all intermediate frequencies between the start and end frequencies. A subband may have a predefined bandwidth, like 20 MHz. When using a plurality of subbands, the operation is also referred to as a wideband operation.

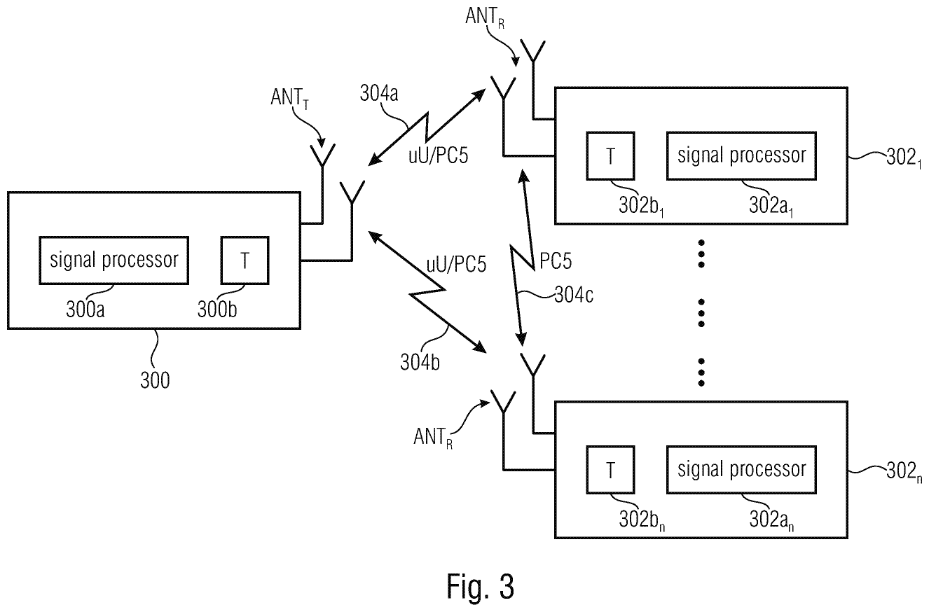

Embodiments of the present invention may be implemented in a wireless communication system as depicted in FIG. 1 including base stations and users, like mobile terminals or IoT devices. FIG. 3 is a schematic representation of a wireless communication system including a transmitter 300, like a base station, and one or more receivers 302₁ to 302ₙ, like user devices, UEs. The transmitter 300 and the receivers 302 may communicate via one or more wireless communication links or channels 304a, 304b, 304c, like a radio link. The transmitter 300 may include one or more antennas ANT_{T} or an antenna array having a plurality of antenna elements, a signal processor 300a and a transceiver 300b, coupled with each other. The receivers 302 include one or more antennas ANT_{R} or an antenna array having a plurality of antennas, a signal processor 302a₁, 302aₙ, and a transceiver 302b₁, 302bₙ coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs 302 and the base stations 300 may operate in accordance with the inventive teachings described herein.

Network Entity

The present invention provides (see for example claim 1) an apparatus for a wireless communication system,

wherein the apparatus is to use a plurality of frequency bands for a communication with one or more network entities, e.g., one or more user devices or one or more base stations, in the wireless communication system,

wherein the apparatus is to receive from a transmitter or the one or more network entities a transport block, TB, the TB being split into a plurality of code block groups, CBGs, each CBG including one or more code blocks, CBs, and being confined to one of the plurality of frequency bands,

wherein the apparatus is to provide or predict a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback, and

wherein the apparatus is to compress the feedbacks and/or the predicted feedbacks for each of the CBGs into a compressed feedback based on an interference pattern on one or more of the frequency bands which is detectable at the apparatus and the transmitter or the one or more network entities, e.g. Listen-before-Talk, LBT, failure, and to transmit to the one or more of the network entities the compressed feedback.

In accordance with embodiments (see for example claim 2), to compress the feedbacks and/or the predicted feedbacks, the apparatus is to apply a lossless compression scheme or a lossy compression scheme, e.g., a probability-based coding using Huffman codes, or a variable length coding, or a frequency band based compression, or semi-lossy compression.

In accordance with embodiments (see for example claim 3), a successful receipt of the CBG, e.g., an acknowledgement, ACK, is indicated by a first value, e.g., a first bit value, and a non-successful receipt of the CBG, e.g., a non-acknowledgement, NACK, is indicated by a second value, e.g., a second bit value.

In accordance with embodiments (see for example claim 4), to compress the feedbacks or the predicted feedbacks, the apparatus is to apply a variable length code book, the codebook including codes identifying some or all patterns of ACKs and NACKs for the plurality of CBGs, the length of a code increasing with the number of NACKs in case ACKs have a higher probability than NACKs, or increasing with the number of ACKs in case NACKs have a higher probability than ACKs

In accordance with embodiments (see for example claim 5), to compress the feedbacks or the predicted feedbacks, the apparatus is to represent the feedback or the predicted feedback for each frequency band by one value, the one value having the first value in case all of the CBGs in a frequency band are or are predicted to be successfully received, or the second value in case one of the CBGs in a frequency band is or is predicted to be not successfully received.

In accordance with embodiments (see for example claim 6), to compress the feedbacks or the predicted feedbacks, the apparatus is configured with a certain number of feedback values, e.g., HARQ bits, to transmit the feedbacks or the predicted feedbacks, the certain number of bits being less than a maximum number of CBGs possible in the TB.

In accordance with embodiments (see for example claim 7), the apparatus is to rearrange a mapping of the feedback values using a pre-defined set of rules.

In accordance with embodiments (see for example claim 8),

in case there is a sufficient number of feedback values, the apparatus is to represent the feedback or the predicted feedback for each CBG by one value, the one value having the first value in case the CBG is or is predicted to be successfully received, or the second value in case the CBG is or is predicted to be not successfully received, and

in case there is an insufficient number of feedback values, the apparatus is to represent the feedback or the predicted feedback for each frequency band by one value, the one value having the first value in case all of the CBGs in a frequency band are successfully received, or the second value in case one of the CBGs in a frequency band is not successfully received.

In accordance with embodiments (see for example claim 9),

in case of a failure of one or more of the frequency bands, the apparatus is to
represent the feedback or the predicted feedback for each failed frequency band by one value, the one value indicating that all of the CBGs in the failed frequency band are not successfully received, or
represent the feedback or the predicted feedback for each CBG in the one or more failed frequency bands by one value, the one value indicating that the CBG is not successfully received.

In accordance with embodiments (see for example claim 10),

a failure of one or more of the frequency bands is due to an interference in a band exceeding a certain threshold or another channel condition not meeting a certain criterion, or

one or more or all of the plurality of frequency bands are unlicensed subbands on which a communication is allowed for a certain transmission time, COT, responsive to a successful Listen-Before-Talk, LBT, and a failure of one or more of the frequency bands is due to a failed LBT for one or more of the unlicensed subbands

In accordance with embodiments (see for example claim 11), one or more or all of the frequency bands are unlicensed subbands, and wherein
following a successful Listen-Before-Talk, LBT, for one or more unlicensed subbands, a communication is allowed during a certain transmission time, (COT) in an available unlicensed subband.
following a failed Listen-Before-Talk, LBT, for one or more unlicensed subbands, a communication is not allowed in a non-available unlicensed subband.

The present invention provides (see for example claim 12) an apparatus for a wireless communication system,

wherein the apparatus is to use a plurality of frequency bands for a communication with one or more network entities, e.g., one or more user devices or base stations, in the wireless communication system,

wherein the apparatus is to receive a transport block, TB, the TB being split into a plurality of code block groups, CBG, each CBG including one or more code blocks, CBs, and being confined to one of the plurality of frequency bands, and one or more of the plurality of CBGs spanning the TB duration,

wherein the apparatus is to provide a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and

wherein, in case of a failure of one or more of the frequency bands, the apparatus is to reduce the feedback or the predicted feedbacks, e.g., a number of bits for the feedback or the predicted feedback, according to the failed frequency bands.

In accordance with embodiments (see for example claim 13), in case of a failure of one or more of the frequency bands, the apparatus is to
not send a feedback for the failed frequency bands, or
send a compressed version of the feedback for the failed frequency bands.

In accordance with embodiments (see for example claim 14), the compressed version of the feedback for the failed frequency bands includes:
for each non-failed frequency bands, a first value, e.g., a first bit value, indicating a successful receipt of the CBG, e.g., an acknowledgement, ACK, or a second value, e.g., a second bit value, indicating by and a non-successful receipt of the CBG, e.g., a non-acknowledgement, NACK, and
for each failed frequency bands, one value indicating that all of the CBGs in the failed frequency bands are not successfully received.

In accordance with embodiments (see for example claim 15), the compressed version of the feedback for the failed frequency bands includes values indicating the failed frequency bands, thereby subjecting all the CBG confined in the failed frequency bands to a retransmission.

In accordance with embodiments (see for example claim 16),

a failure of one or more of the frequency bands is due to an interference in a band exceeding a certain threshold or another channel condition not meeting a certain criterion, or

one or more or all of the plurality of frequency bands are unlicensed subbands on which a communication is allowed for a certain transmission time, COT, responsive to a successful Listen-Before-Talk, LBT, and a failure of one or more of the frequency bands is due to a failed LBT for one or more of the unlicensed subbands, or

one or more or all of the plurality of frequency bands are unlicensed subbands on which a communication is allowed for a certain transmission time, COT, responsive to a successful channel assessment procedure (e.g. RTS CTS), and a failure of one or more of the frequency bands is due to a channel assessment for one or more of the unlicensed subbands.

In accordance with embodiments (see for example claim 17), the apparatus is to receive the subband results or is to detect that one or more frequency bands fails.

In accordance with embodiments (see for example claim 18), the apparatus is to detect that a subband fails, when determining:
that all CBGs in the suband are not successfully received, e.g., are erroneously decoded, and
that a reference signal detection, e.g., a DMRS detection, on the subband fails, or
that the subband or channel is busy, e.g., using a RTS CTS procedure, wherein, responsive to determining the subband to be busy, the apparatus may omit sending clear to send, CTS, to the transmitter or the one or more network entities.

The present invention provides (see for example claim 19) an apparatus for a wireless communication system,

wherein the apparatus is to use a plurality of frequency bands for a communication with one or more network entities, e.g., one or more user devices or one or more base stations, in the wireless communication system,

wherein the apparatus is to receive a transport block, TB, the TB being split into a plurality of code block groups, CBGs, each CBG including one or more code blocks, CBs, and being confined to one of the plurality of frequency bands,

wherein the apparatus is to provide or predict a regular feedback for each of the CBGs indicating a successful and/or a non-successful receipt of the CBG, e.g., a hybrid automatic repeat request, HARQ, feedback, and

wherein, in case an amount of interference on one or more of the frequency bands which is detectable at the receiver, e.g. an interference due to a hidden node problem, exceeds a certain threshold, the apparatus is to transmit an early feedback for one or more CBGs ahead of any regular feedback, the early feedback indicating for the one or more CBGs that a CBG or parts of a CBG are not received correctly or are predicted to be not decodable.

In accordance with embodiments (see for example claim 20), the apparatus is to determine the amount of interference on a frequency band based on measurements of certain channel occupancy metrics, e.g., a DMRS decorrelation, an RSSI or the like.

In accordance with embodiments (see for example claim 21), the interference is due to a hidden node issue.

In accordance with embodiments (see for example claim 22), the apparatus is to transmit the early feedback on one or more configured or pre-configured resources in one or more of the frequency bands, e.g., using respective indicator channels on the frequency bands.

In accordance with embodiments (see for example claim 23), the early feedback includes one of the following:
a predicted HARQ feedback,
a prediction of how much additional redundancy is needed,
a compressed HARQ feedback,
an indication of the frequency band where the amount of interference exceeded the threshold,
a single bit indicting that the amount of interference exceeded the threshold on any one of the frequency bands.

In accordance with embodiments (see for example claim 24), one or more or all of the frequency bands are unlicensed subbands, and wherein
following a successful Listen-Before-Talk, LBT, for one or more unlicensed subbands, a communication is allowed during a certain transmission time, (COT) in an available unlicensed subband, or
following a failed Listen-Before-Talk, LBT, for one or more unlicensed subbands, a communication is not allowed in a non-available unlicensed subband, or
following a successful channel assessment procedure, e.g. RTS/CTS, for one or more unlicensed subbands, a communication is allowed during a certain transmission time, (COT) in an available unlicensed subband, or
following a failed channel assessment procedure, e.g. RTS/CTS, for one or more unlicensed subbands, a communication is not allowed in a non-available unlicensed subband.

The present invention provides (see for example claim 25) an apparatus for a wireless communication system,

wherein the apparatus is to use a plurality of frequency bands for a communication with one or more network entities, e.g., one or more user devices or one or more base stations, in the wireless communication system,

wherein the apparatus is to transmit to a receiver a transport block, TB, the TB being split into a plurality of code block groups, CBGs, each CBG including one or more code blocks, CBs, and being confined to one of the plurality of frequency bands,

wherein the apparatus is to receive from the receiver
a regular feedback or a regular predicted feedback for each of the CBGs indicating a successful and/or a non-successful receipt of the CBG, e.g., a hybrid automatic repeat request, HARQ, feedback, and
an early feedback ahead of any regular feedback for one or more CBGs on one or more of the frequency bands experiencing an amount of interference, exceeding a certain threshold, and

wherein, responsive to the early feedback, the apparatus is to transmit to the receiver a retransmission for the one or more CBGs on one or more frequency bands which are not affected by the interference.

In accordance with embodiments (see for example claim 26), the apparatus is to redistribute the resources on the one or more frequency bands which are not affected by the interference to one or more other receivers which are not affected by the interference.

In accordance with embodiments (see for example claim 27),

the apparatus comprises a user device, UE, wherein the UE comprises one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, and/or

the apparatus comprises a base station, BS, wherein the BS is implemented as mobile or immobile base station and comprises one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

System

The present invention provides (see for example claim 28) a wireless communication system, comprising one or more user devices and one or more base station, wherein one or more of the user devices and/or one or more of the base stations comprise an inventive apparatus.

Methods

The present invention provides (see for example claim 29) a method for providing feedback in a wireless communication system, the method comprising:

receiving, by a receiver, from one or more network entities, e.g., one or more user devices or one or more base stations, in the wireless communication system, a transport block, TB, using a plurality of frequency bands, the TB being split into a plurality of code block groups, CBCs, each CBG including one or more code blocks, CBs, and being confined to one of the plurality of frequency bands,

providing or predicting a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback,

compressing the feedbacks and/or the predicted feedbacks for each of the CBGs into a compressed feedback based on an interference pattern on one or more of the frequency bands which is detectable at the receiver and the one or more network entities, e.g. Listen-before-Talk, LBT, failure, and

transmitting to one or more of the network entities the compressed feedback.

The present invention provides (see for example claim 30) a method for providing feedback in a wireless communication system, the method comprising:

receiving, by a receiver, a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration,

providing a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and

in case of a failure of one or more of the frequency bands, reducing the feedback or the predicted feedbacks, e.g., a number of bits for the feedback or the predicted feedback, according to the failed frequency bands.

The present invention provides (see for example claim 31) a method for providing feedback in a wireless communication system, the method comprising:

receiving, by a receiver, a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration,

providing or predicting a regular feedback for each of the CBGs indicating a successful and/or a non-successful receipt of the CBG, e.g., a hybrid automatic repeat request, HARQ, feedback, and

in case an amount of interference on one or more of the frequency bands which is detectable at the receiver, e.g. an interference due to a hidden node problem, exceeds a certain threshold, transmitting an early feedback for one or more CBGs ahead of any regular feedback, the early feedback indicating for the one or more CBGs that a CBG or parts of a CBG are not received correctly or are predicted to be not decodable.

The present invention provides (see for example claim 32) a method for providing feedback in a wireless communication system, the method comprising:

transmitting to a receiver a transport block, TB, using a plurality of frequency bands for a communication with one or more network entities, e.g., one or more user devices or base stations, in the wireless communication system, the TB being split into a plurality of code block groups, CBG, each CBG including one or more code blocks, CBs, and being confined to one of the plurality of frequency bands, and one or more of the plurality of CBGs spanning the TB duration,

receiving from the receiver a regular feedback or a regular predicted feedback for each of the CBGs indicating a successful and/or a non-successful receipt of the CBG, e.g., a hybrid automatic repeat request, HARQ, feedback, or an early feedback ahead of any regular feedback for one or more CBGs on one or more of the frequency bands experiencing an amount of interference, exceeding a certain threshold, and

responsive to the early feedback, transmitting to the receiver a retransmission for the one or more CBGs on one or more frequency bands which are not affected by the interference.

Computer Program Product

The present invention provides a computer program product comprising instructions which, when the program is executed by a computer, causes the computer to carry out one or more methods in accordance with the present invention.

Thus, aspects of the present invention address the above-mentioned problems regarding the signaling overhead associated with the feedback transmissions and the late feedback transmission, for example in URLLC communications. The respective aspects are described in more detail below and it is noted that the aspect may be implemented independent from each other or may be implemented together.

### Aspect 1

In accordance with embodiments of the first aspect of the present invention, the above-described problem regarding the signaling overhead associated with feedback transmissions in a data transmission in which the TB is split into a plurality of CBGs, as is illustrated in FIG. 2, is addressed by compressing the feedback associated with the respective CBGs dependent on an interference pattern on one or more of the frequency bands. In accordance with other embodiments of the first aspect, the feedback associated with the respective CBGs is reduced dependent on a failure of one or more of the more of the frequency bands. In other words, in accordance with the embodiments of the first aspect of the present invention, the signaling overhead regarding the feedback transmission is reduced by either compressing the feedback or reducing the feedback dependent on the state of the respective frequency bands, i.e., as to whether a certain frequency band allows for a transmission of data or not. In the latter case, no transmission may be possible because the interference on the respective frequency band, as detected by the receiver and by the transmitter may be too high, i.e., the amount of interference is above a certain threshold, or in case the transmitter did not transmit on one of the frequency bands to be used for the wideband operation, i.e., the subband failed, for example in case of an unsuccessful LBT for a certain subband in the NR-U operation.

In accordance with embodiments, the transmitter and/or the receiver may detect an interference pattern or an amount of interference on one or more of the frequency bands which indicates that the respective frequency band may not be used for a transmission. For example, the transmitter or the receiver may perform an LBT, as described above, and an LBT failure indicates that on the respective frequency band or sub-channel an interference pattern or an amount of interference is present, for example, from another transmitter of another communication system which does not allow using the frequency band. Another example is the hidden node problem, i.e., another device may not hear the gNB because of a physical distance to the gNB, however, it is close to the receiving UE and transmits on at least a part of the resources used for the data transmission between the gNB and the receiving UE and a substantial amount of interference from this other device may be experienced by the receiving UE on one or more of the frequency bands.

In such a situation, the receiver may compress the feedback, for example the CBG-based HARQ feedback for each frequency band, for example for each subband experiencing an LBT failure or an amount of interference above a threshold, using a lossless compression scheme or a lossy compression scheme. The compression schemes may include a probability-based coding using Hoffman codes or a variable length coding, or a frequency band based compression or a semi-lossy compression.

The variable length codebook may indicate, using for example a Hoffman-like source coding compression, respective ACKs/NACKs associated with the CBGs. In accordance with embodiments, a probability-based coding, for example Huffman codes may be employed as due to the nature of the fading channels, the failing probabilities of the different CBGs are not independent. For example, in case a first CBG in a subband failed, the probability that the others in the same subband fail as well increases significantly. Subband puncturing further increases this effect. When applying the probability based coding of the CBG feedback, such as Huffman codes, the feedback overhead is significantly reduced. In case of subband puncturing, i.e., in case certain subbands are not used, this may be also considered for the underlying probability distribution and in case the UE detects a missing subband it adapts the underlying probability distribution on which the coding is based.

In accordance with other embodiments, a lossy compression may be employed. A fixed length compression with a lossy-like coding may employ more NACKs as needed so as to avoid a high number of bits as a feedback, or may employ a NACK even in case not all of the CBGs within a subband failed to avoid feedback overhead. A compression using variable code lengths may be employed that uses a reduced number of codewords having an increasing length so as to signal that certain groups of CBGs are successfully or non-successfully received.

For example, the variable code length may employ an increasing number of bits for signaling the feedback. For example, when considering a scenario in which the receiver determines that, due to the given properties of the frequency bands, a successful transmission of the CBGs in a TB is more likely than a non-successful transmission, i.e., in case a ACK has a higher probability than a NACK, the following variable code length scheme may employed:

| | | |
|---|---|---|
| 0 | → | all ACK, |
| 10 | → | ½ ACK and ½ NACK, |
| 110 | → | ½ NACK and ½ ACK, |
| 1110 | → | ¾ NACKs and ¼ ACKs, |
| 1111 | → | all NACKs |

Thus, when considering the example depicted above in FIG. 2 using a TB with 8 CBGs, the feedback may be as follows:
0 in case all 8 CBGs are successfully received, 8 ACKs.
10 CBG1 to CBG4 are successfully received and CBG5 to CBG8 are non-successfully received, i.e., 4 ACKs/4 NACKs. SB3 and SB4 experience an amount of interference beyond a certain threshold so that no successful reception is possible.
110 CB1 to CBG4 are non-successfully received and CBG5 to CBG8 are successfully received, 4 NACKs/4 ACKs. SB1 and SB2 experience an amount of interference beyond a certain threshold so that no successful reception is possible.
1110 CBG1 to CBG6 are non-successfully received and CBG7 and CBG8 are successfully received, 6 NACKs/2 ACKs. SB1 to SB3 experience an amount of interference beyond a certain threshold so that no successful reception is possible.
1111 all CBGs are non-successfully received, all NACKs, all subbands experience an amount of interference beyond a certain threshold so that no successful reception is possible.

Thus, in this embodiment when assuming an acknowledgement of a successful receipt to have a higher probability than a non-successful reception, and when considering FIG. 2, the “0” means that all CBGs in FIG. 2 are successfully received, i.e., in none of the subbands SB1 to SB4 an interference pattern is experienced by the receiver or by the transmitter that does not allow a transmission over the subband. On the other hand, the feedback 10 is used in case the transmitter and/or the receiver detect an interference pattern in subband SB3 and SB4, e.g., a failure in these subbands and no transmission of CBG5 to CBG8. In case of a feedback 110 subbands SB1 and SB2 failed while subbands SB3 and SB4 allow for the transmission. In case of the feedback 1110, subbands SB1 to SB3 failed and only CBG7 and CBG8 in subband 4 are transmitted. In case of 1111, all subbands failed.

In case the receiver determines that a non-successful transmission is more likely, i.e., a NACK has a higher probability than a NACK, the above scheme may be reversed as follows:

| | | |
|---|---|---|
| 0 | → | all NACK, |
| 10 | → | ½ NACK and ½ NACK, |
| 110 | → | ½ ACK and ½ NACK, |
| 1110 | → | ¾ ACKs and ¼ NACKs, |
| 1111 | → | all ACKs |

Another embodiment employing a lossy compression scheme may indicate the feedback in the following manner, for example, when assuming three CBGs in a TB transmitted from the transmitter to the receiver.

| | | |
|---|---|---|
| 0 | → | all ACK |
| 10 | → | CBG1 NACK and CBG2/3 ACK |
| 110 | → | CBG2 NACK and CBG1/3 ACK |
| 1110 | → | CBG3 NACK and CBG1/2 ACK |
| 1111 | → | all NACK |

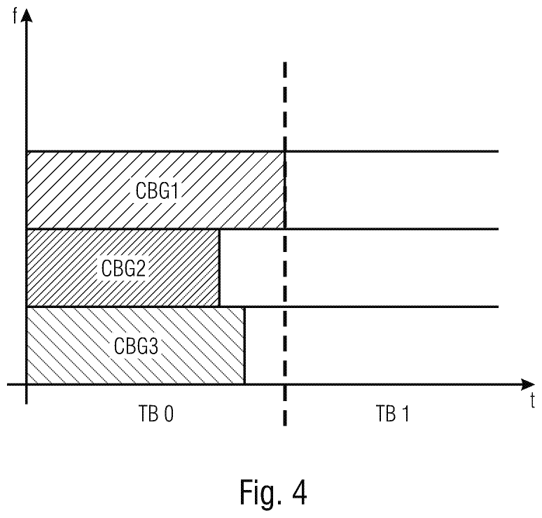

As is indicated in FIG. 4, in case of assuming three CBGs within a TB in a multi-band operation using three frequency bands, each frequency band in the TB includes only one CBG that may span a part of or the entire TB duration, and the feedback 0 means that on none of the subbands SB1 to SB3 an interference pattern is experienced by the transmitter and/or the receiver indicating that no transmission is possible. The feedback 10 indicates that an interference pattern is experienced on subband SB1 so that CBG1 may not be received, while no interference is experienced on subbands SB2 and SB3 so that the receipt of CBG2 and CBG3 may be acknowledged. The feedback 110 indicates that an interference is experienced on subband SB2 but not on subbands SB1 and SB3 so that CBG2 is associated with a NACK while for CBG1 and CBG3 a ACK is indicated. The feedback 1110 indicates that the subband SB3 experiences interference, so that the feedback associated with CBG3 is a NACK while the feedback for CBG1 and CBG2 is an ACK. The feedback 1111 indicates that on all subbands SB1 to SB3, interference is experienced so that all CBGs are indicated with a NACK.

In this embodiment, other than in the preceding embodiment, in which, in general, the probability of a ACK or a NACK over the entire frequency bands was considered, in this case the variable length is determined dependent on the failing probability determined in the system, for example by the transmitter and/or the receiver, for each subband. In the above-described example, the failing probabilities of the first subband SB1 is considered higher than the failing probability of the second subband which, in turn, is higher than the failing probability for the third subband. In other words, the failing of the first SB1 is most likely and the failing of the third subband is least likely so that for the more likely situations, the shorter code length is employed while for the less likely situations longer codewords are used.

In accordance with further embodiments, rather than sending a compressed feedback associated with the CBGs or groups of CBGs, a frequency or subband-based feedback may be employed which uses frequency band or subband-based ACKs/NACKs which also leads to a lossy compression of the feedback. For example, when considering FIG. 2 above, such a lossy compression scheme may use one bit per subband SB1, SB2, SB3 or SB4 for indicating an ACK or a NACK for all CBGs within this subband. Thus, in case the transmitter/receiver determines a certain interference pattern, for example an amount of interference above a certain threshold or an LBT failure for a certain subband, say subband SB4 in FIG. 2, the feedback for this subband is compressed to a one-bit feedback.

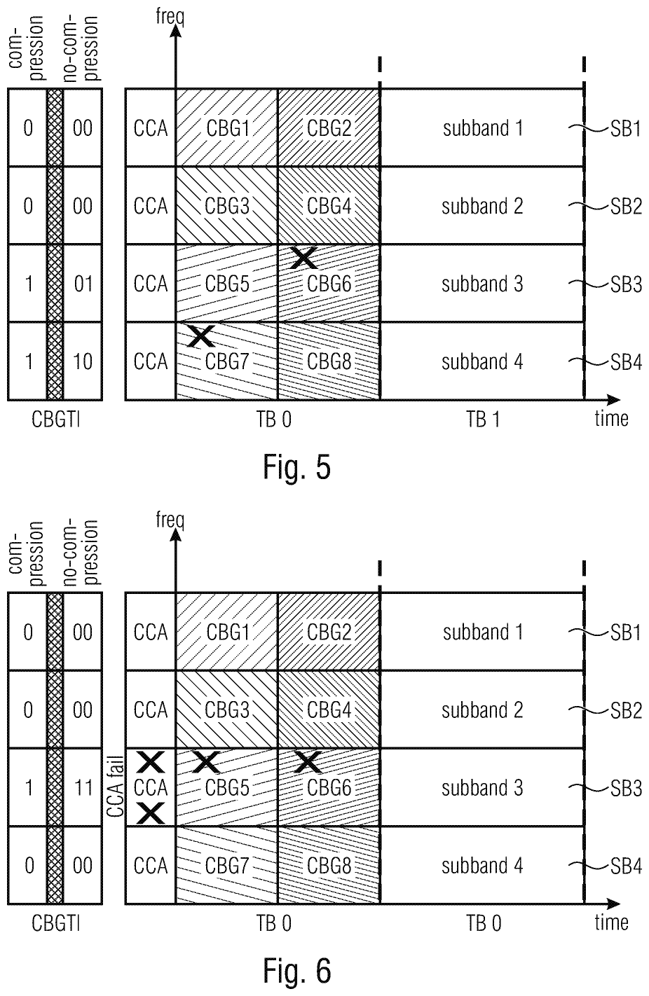

FIG. 5 illustrates an embodiment applying a lossy compression on the basis of a subband based feedback. FIG. 5 is similar to FIG. 2 but indicates, in addition, on the left hand side the CBGTI, the CBG transmission indicator. For example the gNB may define for a UE a maximum number of CBG transmit information feedback that may be indicated in a DCI. In FIG. 5, the CBGTI indicates, in the right hand column, the conventional non-compressed feedback in case CBG6 and CBG7 are not successfully received at the receiver, as is indicated by “x”. The feedback for each subband may include, conventionally, one bit per CBG. Two CBGs are confined in each subband so that for each subband the feedback includes two bits. Thus, the conventional feedback is 00000101, namely for SB1 “00” indicates ACKs for CBG1 and CBG2, for SB2 “00” indicates ACKs for the CBG3 and CBG4, for SB3 “01” indicates an ACK for CBG5 and a NACK for CBG6, and for SB4 “10” indicates a NACK for CBG7 and an ACK for CBG8.

To reduce the signaling overhead, i.e., the number of bits that need to be signaled to the transmitter as the feedback information, and accordance with the present embodiment, the subband-based lossy compression scheme for indicating ACKs/NACKs may be employed, in accordance with which one bit per subband or frequency band is used as is illustrated in the left hand column of the CBGTI indicating the compressed feedback. In the depicted embodiment, the compressed feedback is “0” in case an interference pattern or amount of interference not causing a failure in the transmission is experienced at the transmitter or the receiver a subband, like subbands SB1 and SB2 in FIG. 5. On the other hand, such an interference pattern is experienced for SB3 and SB4 so that for these two subbands the feedback is “1”, meaning a NACK for CBG5 to CBG6 despite the fact that in subbands SB3 and SB4 only CBG6 and CBG7 are not successfully received due to the interference pattern while CBG5 and CBG8 may be received successfully. Thus, in accordance with the present embodiment, the feedback is reduced or compressed from 00000101 to 0011. Naturally, in case more than the two CBGs per subband are used, meaning, conventionally, a corresponding number of bits, the amount of feedback is reduced even more significantly, for example in case of eight CBGs per subband and a total of four subbands from 64 bits to 4 bits.

In accordance with yet other embodiments, an adaptive semi-lossy compression scheme may be employed. Conventionally, as mentioned above, a number of bits to be sent as HARQ feedback is equal to the configured maximum number of CBGs. Thus, in case of 8 CBGs, as shown in FIG. 5, the number of bits for the HARQ feedback is 8, as is illustrated in the right hand column of CBGTI indicating the non-compressed feedback. The 8 HARQ feedback bits are used independent from the actual number of CBGs in the transmission, so that, for example, in case only 4 CBGs per TB still 8 HARQ feedback bits are provided as this is the maximum number of possible CBGs per TB. However, when using less than the maximum number of CBGs, a signaling overhead with regard to the HARQ feedback is experienced, as not the entire number of feedback is needed. Therefore, in accordance with embodiments, an adaptive semi-lossy compression scheme for the CBG HARQ-ACK feedback is provided and, in addition to the maximum number of CBGs, a certain number n is configured, for example by the gNB, which indicates the number of HARQ feedbacks to be used and to be transmitted per PUSCH/PDSCH/PSSCH. Based on the actual number of CBGs and the subbands experiencing to much interference, the receiver may rearrange the mapping of the feedback bits using pre-defined rules. For example, in case sufficient bits are available, each CBG may be mapped to a single feedback bit, and in case not sufficient bits are available for each CBG, for example in case n is smaller than the actual number of CBGs used, the CBGs may be merged subband-wise as described above with reference to FIG. 5.

In accordance with yet other embodiments of the first aspect, when the CBGs are confined to the subbands as described above with reference to FIG. 2 and to FIG. 5, in case of a failure of a subband, the CBGs are not transmitted. For example, in case the transmitter that performed LBT experiences an LBT failure for a certain frequency band or subband, the CBGs scheduled for transmission on this subband are not transmitted. To reduce the HARQ feedback signaling overhead, the receiver, when being aware that the LBT failure occurred on one of the subbands, may, in accordance with embodiments, not send any HARQ feedback for any of the failing frequency bands or subbands. Further, the transmitter which is aware that the subband transmission failed, may autonomously perform a retransmission of the CBGs for the failed subband.

In accordance with other embodiments, instead of sending not any HARQ feedback, the receiver may compress the conventional feedback by sending only a one bit CBG-based NACK for the failing subbands, indicating that all CBGs in the failing subband were not successfully received. FIG. 6 illustrates an embodiment, similar to FIG. 2, in which subband SB3 is a failed subband, i.e., the CCA or LBT was not successful as indicated by “x x” in the CCA field. In such a case, the conventional feedback which includes 8 bits may be reduced to 7 bits as in accordance with the present embodiment, the feedback for the failed subband may be reduced to a single bit indicating a NACK (by signaling a “1” for the entire subband). Thus, the receiver may send n bits for the subbands received and a single bit for the failed bit.

In accordance with other embodiments, instead of sending a single bit, the receiver may send only the number of bits needed to identify the failing subband. For example, when considering the situation in FIG. 6 and assuming that each subband includes more than two CBGs, the conventional feedback for each subband is 3 or more bits. When employing 4 subbands, the signaling for a failed subband indicates the actual subband number, and in the embodiment of FIG. 4, the receiver signals “10” indicating that the third subband failed.

Responsive to the signaling of a failed subband, the transmitter may perform a retransmission of the CBGs for the failed subband.

The receiver may become aware of a failed subband, for example by receiving an identification from the gNB for which of the subbands the LBT was successful, the LBT results may be transmitted to the receiver. In accordance with other embodiments, in case the failing subbands are not signaled to the receiver, the receiver, nevertheless, may detect such subbands by determining that all CBGs in the subbands to be erroneously decoded, due to CRC errors or NACKs, and/or by determining that all DMRS detection of the subbands failed, for example a correlation of the DMRS, and/or by determining that the subband or channel is busy, e.g., using a Ready-To-Send/Clear-To-Send, RTS/CTS, procedure, wherein, responsive to determining the subband to be busy, the apparatus may omit sending clear to send, CTS, to the transmitter.

In other words, in accordance with this embodiment of the present embodiment, the receiver may reduce the number of bits used for the feedback according to the failing subbands.

When considering FIG. 6, assuming the four subbands SB1 to SB2 with the two bit per subband HARQ feedback transmission, with no DMRS failure, i.e., no failing subbands and/or all NACK on any subband, the maximum HARQ feedback for the four bands is sent, namely eight bits. In case the receiver becomes aware that a certain subband failed, for example due to a DMRS failure on one subband or the indication of a subband that failed by the gNB, the receiver, when not sending a feedback for the failed subband, only employs the HARQ feedback for three bands which is then only six bits and, when two subbands fail, it is only four bits, thereby reducing the signaling overhead associated with the HARQ feedback dependent on the failing subbands.

Thus, embodiments of the first aspect of the present invention provide for a reduction in the HARQ feedback from a receiver to a transmitter by reducing, for example, the number of bits associated for a feedback for CBGs on subbands or frequency bands experiencing a certain interference pattern or a certain amount of interference in a way as described above.

### Aspect 2

Embodiments of the second aspect of the present invention address the issue of a feedback transmission, also referred to as a regular feedback, only once a data transmission is received at the receiver and determined to be successful or non-successful. As stated above, for certain applications or services that may use a certain reliability and/or a certain latency, like URLLC services or applications, a retransmission occurring only once the reception has been completed at the receiver may be too late. For example, in case an amount of interference on one or more of the frequency bands used for the multi-band operation, that may be detected at the receiver, is high, lie above a threshold, there is no other solution than providing the HARQ feedback after the transmission which, however, causes an additional delay.

The amount of interference detectable at the receiver may be due to, for example, the hidden node problem, i.e., another device may not hear the gNB because of a physical distance to the gNB, however, it is close to the receiving UE and transmits on at least a part of the resources used for the data transmission to the receiving UE so that, on one or more of the frequency bands a substantial amount of interference from this other device is experienced by the receiving UE. The amount of interference may be determined by the receiving UE based on measurements of certain channel occupancy metrics, for example a DMRS decorrelation, an RSSI or the like.

In accordance with embodiments of the second aspect of the present invention, the problem with the regular feedback in such situations is addressed by providing an early feedback that is transmitted ahead of any regular feedback. The early feedback may be signaled the amount of interference detected by the receiver exceeds a certain or predefined threshold, and responsive to the early feedback, a transmitter may perform a retransmission for one or more of the CBGs in the affected frequency band. The early feedback may indicate for the one or more CBGs that a CBG or parts of a CBG are not received correctly or are predicted to be not decodable.

The early feedback may be transmitted in an early feedback channel, for example an early HARQ indicator channel or a hidden node indicator channel, which may be provided in one or more of the frequency bands, for example in one or more of the subbands illustrated above in FIG. 2 for example. Once the receiving UE determines the situation in which an amount of interference, which may heavily effect the data transmission quality on the channel, is experienced, the UE may report an early feedback or a hidden note indication on one or more of the indicator channels on a different frequency band than the one on which the interference is experienced. The resources for the indicator channel on the different frequency bands may be configured in an RRC message or may be dynamically allocated using DCIs.

Responsive to the early feedback, the transmitter, like the gNB, may perform a fast retransmission on those frequency bands that are not affected by the interference, like those not affected by the hidden node problem.

In accordance with embodiments, the gNB being aware of the affected frequency bands may redistribute the resources on the affected frequency band to other UEs which are not affected by the hidden node issue.

The early HARQ feedback or the hidden node indication may include a predicted HARQ feedback, or a prediction of how much additional redundancy is needed, or a compressed HARQ feedback as described above with reference to the first aspect of the present invention, or a subband indication explicitly indicating the subband in which the amount of interference exceeds a certain threshold, or it may be a single bit indicating that in one or more of the subbands the interference amount exceeds the predefined threshold, for example that the hidden node problem occurred somewhere, thereby causing a complete retransmission of the TB at a later time.

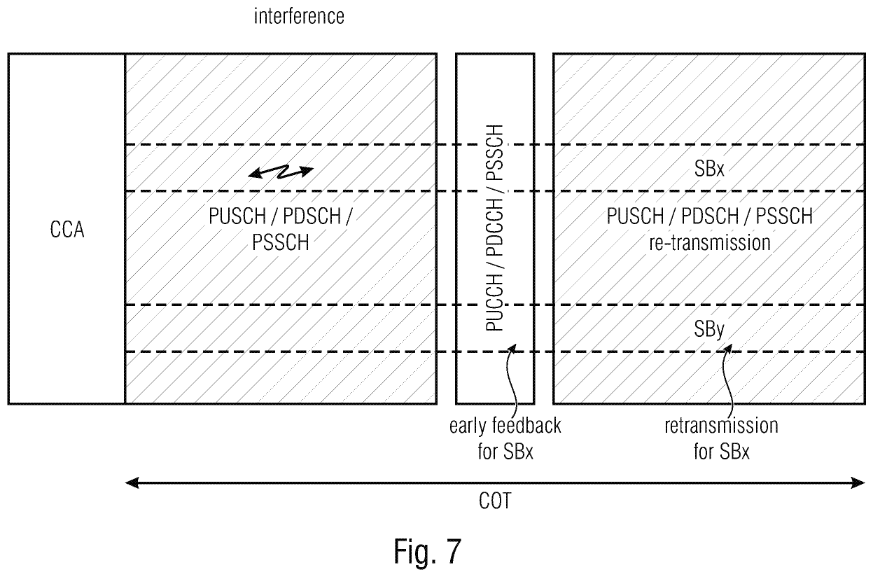

In accordance with embodiments operating in the unlicensed spectrum, the early feedback may be transmitted within the transmitter initiated COT. FIG. 7 illustrates an embodiment for a transmitter initiated COT including multiple subbands and employing an early feedback. For example, following a successful LBT for SBx, in a first part of the COT, the transmitter transmits the data using the PUSCH/PDSCH/PSSCH. However, the receiver determines an amount of interference on the subband that is above a certain level or threshold, so that the UE signals ahead of or earlier than the regular feedback, which is only provided once the transmission is completed, the early feedback which may signal an ACK/NACK in the PUCCH/PDCCH/PSCCH in another subband to the transmitter, like SBy in FIG. 7. In accordance with embodiments, in case the interference amount exceeds a certain level or a certain threshold, the NACK is sent as early HARQ so that in a later part of the transmitter initiated COT a retransmission may be performed on the PUSCH/PDSCH/PSSCH of another subband SBy as is indicated in FIG. 7. The retransmission may be in the same subband as the feedback or in a different subband.

In accordance with embodiments, the frequency bands may be unlicensed subbands so that following a successful Listen-Before-Talk, LBT, for one or more unlicensed subbands, a communication is allowed during a certain transmission time, (COT) in an available unlicensed subband, or following a failed Listen-Before-Talk, LBT, for one or more unlicensed subbands, a communication is not allowed in a non-available unlicensed subband, or following a successful channel assessment procedure, e.g. RTS/CTS, for one or more unlicensed subbands, a communication is allowed during a certain transmission time, (COT) in an available unlicensed subband, or following a failed channel assessment procedure, e.g. RTS/CTS, for one or more unlicensed subbands, a communication is not allowed in a non-available unlicensed subband.

Thus, the inventive approach as described with regard to the second aspect of the present invention avoids latencies or delays as they are experienced when employing regular HARQ feedback that is generated once the transmission has been completed. Embodiments provide, dependent on a monitoring of the interference level on a certain subband, an early feedback, if needed, so as to request a retransmission of CBGs associated with the affected subband.

General

In the embodiments described above, reference has been made to a HARQ feedback, however, the invention is not limited to a HARQ feedback, rather, any feedback mechanism may be employed. Further, in accordance with further embodiments all aspects may employ a predicted feedback as well, like predicted HARQ. Further, in accordance with other embodiments, the feedback may signal or indicate that there is no need for a redundancy for the data or that there is a need for some redundancy for the data. In accordance with yet other embodiments, the feedback may signal or indicate an amount of additional redundancy needed for the data. For example, the feedback may indicate that no more redundancy is needed for the data, or that a little more redundancy is needed, or that a lot more redundancy is needed. In other words, an decreasing or increasing amount of redundancy may be signaled.

In the embodiments described above, reference is made to a frequency band experiencing an interference. In accordance with embodiments, a failure of one or more of the frequency bands may be due to an interference in a band exceeding a certain threshold or another channel condition not meeting a certain criterion. In accordance with other embodiments, when one or more or all of the plurality of frequency bands are unlicensed subbands on which a communication is allowed for a certain transmission time, COT, responsive to a successful Listen-Before-Talk, LBT, a failure of one or more of the frequency bands may be due to a failed LBT for one or more of the unlicensed subbands. In accordance with yet other embodiments, when one or more or all of the plurality of frequency bands are unlicensed subbands on which a communication is allowed for a certain transmission time, COT, responsive to a successful channel assessment procedure (e.g. RTS CTS), a failure of one or more of the frequency bands may be due to a channel assessment for one or more of the unlicensed subbands.

Embodiments of the present invention have been described in detail above, and the respective embodiments and aspects may be implemented individually or two or more of the embodiments or aspects may be implemented in combination.

Further, the embodiments described herein may be employed when communicating via a single subband that may be an unlicensed subband. However, the inventive approach is not limited to a communication over a single subband, rather, the communication may be over a plurality of subbands for a communication with one or more entities, like other UE(s) or other gNB(s), in the wireless communication system, and some or all of the plurality of subbands may be unlicensed subbands on which a communication is allowed for a certain transmission time (COT) responsive to a successful channel access procedure, e.g. Listen-Before-Talk, LBT, or a request to send/clear to send mechanism, RTS/CTS mechanism, that may be used for higher frequencies.

With regard to the above-described embodiments of the various aspects of the present invention, it is noted that they have been described in an environment in which a communication is between a transmitter, like a gNB or a UE, and a receiver, like a UE and a gNB. However, the invention is not limited to such a communication, rather, the above-described principles may equally be applied for a device-to-device communication, like a D2D, V2V, V2X communication. In such scenarios, the communication is over a sidelink between the respective devices. The transmitter is a first UE and the receiver is a second UE communicating using the sidelink resources.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, may be one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, and/or the base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

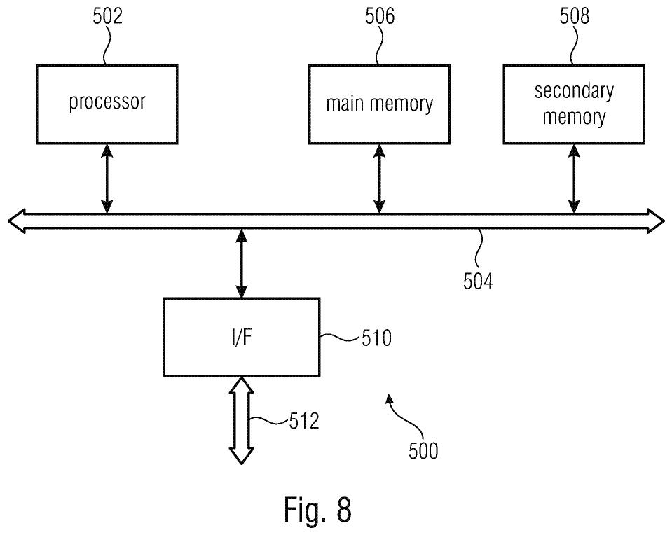

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF ACRONYMS AND SYMBOLS

BS Base Station
CBR Channel Busy Ratio
D2D Device-to-Device
EN Emergency Notification
eNB Evolved Node B (base station)
FDM Frequency Division Multiplexing
LTE Long-Term Evolution
PC5 Interface using the Sidelink Channel for D2D communication
PPPP ProSe per packet priority
PRB Physical Resource Block
ProSe Proximity Services
RA Resource Allocation
SCI Sidelink Control Information
SL sidelink
sTTI Short Transmission Time Interval
TDM Time Division Multiplexing
TDMA Time Division Multiple Access
TPC Transmit power control/transmit power command
UE User Entity (User Terminal)
URLLC Ultra-Reliable Low-Latency Communication
V2V Vehicle-to-vehicle
V2I Vehicle-to-infrastructure
V2P Vehicle-to-pedestrian
V2N Vehicle-to-network
V2X Vehicle-to-everything, i.e., V2V, V2I, V2P, V2N

1. An apparatus for a wireless communication system,
wherein the apparatus is to use a plurality of frequency bands for a communication with one or more network entities, e.g., one or more user devices or one or more base stations, in the wireless communication system,
wherein the apparatus is to receive from a transmitter or the one or more network entities a transport block, TB, the TB being split into a plurality of code block groups, CBGs, each CBG comprising one or more code blocks, CBs, and being confined to one of the plurality of frequency bands,
wherein the apparatus is to provide or predict a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback, and
wherein the apparatus is to compress the feedbacks and/or the predicted feedbacks for each of the CBGs into a compressed feedback based on an interference pattern on one or more of the frequency bands which is detectable at the apparatus and the transmitter or the one or more network entities, e.g. Listen-before-Talk, LBT, failure, and to transmit to the one or more of the network entities the compressed feedback.

2. The apparatus of claim 1, wherein, to compress the feedbacks and/or the predicted feedbacks, the apparatus is to apply a lossless compression scheme or a lossy compression scheme, e.g., a probability-based coding using Huffman codes, or a variable length coding, or a frequency band based compression, or semi-lossy compression.

3. The apparatus of claim 1, wherein a successful receipt of the CBG, e.g., an acknowledgement, ACK, is indicated by a first value, e.g., a first bit value, and a non-successful receipt of the CBG, e.g., a non-acknowledgement, NACK, is indicated by a second value, e.g., a second bit value.

4. The apparatus of claim 3, wherein, to compress the feedbacks or the predicted feedbacks, the apparatus is to apply a variable length code book, the codebook comprising codes identifying some or all patterns of ACKs and NACKs for the plurality of CBGs, the length of a code increasing with the number of NACKs in case ACKs comprise a higher probability than NACKs, or increasing with the number of ACKs in case NACKs comprise a higher probability than ACKs

5. The apparatus of claim 3, wherein, to compress the feedbacks or the predicted feedbacks, the apparatus is to represent the feedback or the predicted feedback for each frequency band by one value, the one value comprising the first value in case all of the CBGs in a frequency band are or are predicted to be successfully received, or the second value in case one of the CBGs in a frequency band is or is predicted to be not successfully received.

6. The apparatus of claim 3, wherein, to compress the feedbacks or the predicted feedbacks, the apparatus is configured with a certain number of feedback values, e.g., HARQ bits, to transmit the feedbacks or the predicted feedbacks, the certain number of bits being less than a maximum number of CBGs possible in the TB.

7. The apparatus of claim 6, wherein the apparatus is to rearrange a mapping of the feedback values using a pre-defined set of rules.

8. The apparatus of claim 6, wherein
in case there is a sufficient number of feedback values, the apparatus is to represent the feedback or the predicted feedback for each CBG by one value, the one value comprising the first value in case the CBG is or is predicted to be successfully received, or the second value in case the CBG is or is predicted to be not successfully received, and
wherein, in case there is an insufficient number of feedback values, the apparatus is to represent the feedback or the predicted feedback for each frequency band by one value, the one value comprising the first value in case all of the CBGs in a frequency band are successfully received, or the second value in case one of the CBGs in a frequency band is not successfully received.

9. The apparatus of claim 6, wherein
in case of a failure of one or more of the frequency bands, the apparatus is to
represent the feedback or the predicted feedback for each failed frequency band by one value, the one value indicating that all of the CBGs in the failed frequency band are not successfully received, or
represent the feedback or the predicted feedback for each CBG in the one or more failed frequency bands by one value, the one value indicating that the CBG is not successfully received.

10. The apparatus of claim 6, wherein
a failure of one or more of the frequency bands is due to an interference in a band exceeding a certain threshold or another channel condition not meeting a certain criterion, or
one or more or all of the plurality of frequency bands are unlicensed subbands on which a communication is allowed for a certain transmission time, COT, responsive to a successful Listen-Before-Talk, LBT, and a failure of one or more of the frequency bands is due to a failed LBT for one or more of the unlicensed subbands

11. The apparatus of claim 1, wherein one or more or all of the frequency bands are unlicensed subbands, and wherein
following a successful Listen-Before-Talk, LBT, for one or more unlicensed subbands, a communication is allowed during a certain transmission time, (COT) in an available unlicensed subband.
following a failed Listen-Before-Talk, LBT, for one or more unlicensed subbands, a communication is not allowed in a non-available unlicensed subband.

12. An apparatus for a wireless communication system,
wherein the apparatus is to use a plurality of frequency bands for a communication with one or more network entities, e.g., one or more user devices or base stations, in the wireless communication system,
wherein the apparatus is to receive a transport block, TB, the TB being split into a plurality of code block groups, CBG, each CBG comprising one or more code blocks, CBs, and being confined to one of the plurality of frequency bands, and one or more of the plurality of CBGs spanning the TB duration,
wherein the apparatus is to provide a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and
wherein, in case of a failure of one or more of the frequency bands, the apparatus is to reduce the feedback or the predicted feedbacks, e.g., a number of bits for the feedback or the predicted feedback, according to the failed frequency bands.

13. The apparatus of claim 12, wherein, in case of a failure of one or more of the frequency bands, the apparatus is to
not send a feedback for the failed frequency bands, or
send a compressed version of the feedback for the failed frequency bands.

14. The apparatus of claim 13, wherein the compressed version of the feedback for the failed frequency bands comprises:
for each non-failed frequency bands, a first value, e.g., a first bit value, indicating a successful receipt of the CBG, e.g., an acknowledgement, ACK, or a second value, e.g., a second bit value, indicating by and a non-successful receipt of the CBG, e.g., a non-acknowledgement, NACK, and
for each failed frequency bands, one value indicating that all of the CBGs in the failed frequency bands are not successfully received.

15. The apparatus of claim 13, wherein the compressed version of the feedback for the failed frequency bands comprises values indicating the failed frequency bands, thereby subjecting all the CBG confined in the failed frequency bands to a retransmission.

16. The apparatus of claim 12, wherein
a failure of one or more of the frequency bands is due to an interference in a band exceeding a certain threshold or another channel condition not meeting a certain criterion, or
one or more or all of the plurality of frequency bands are unlicensed subbands on which a communication is allowed for a certain transmission time, COT, responsive to a successful Listen-Before-Talk, LBT, and a failure of one or more of the frequency bands is due to a failed LBT for one or more of the unlicensed subbands, or
one or more or all of the plurality of frequency bands are unlicensed subbands on which a communication is allowed for a certain transmission time, COT, responsive to a successful channel assessment procedure (e.g. RTS CTS), and a failure of one or more of the frequency bands is due to a channel assessment for one or more of the unlicensed subbands.

17. The apparatus of claim 16, wherein the apparatus is to receive the subband results or is to detect that one or more frequency bands fails.

18. The apparatus of claim 12, wherein the apparatus is to detect that a subband fails, when determining:
that all CBGs in the suband are not successfully received, e.g., are erroneously decoded, and
that a reference signal detection, e.g., a DMRS detection, on the subband fails, or
that the subband or channel is busy, e.g., using a RTS CTS procedure, wherein, responsive to determining the subband to be busy, the apparatus may omit sending clear to send, CTS, to the transmitter or the one or more network entities.

19. An apparatus for a wireless communication system,
wherein the apparatus is to use a plurality of frequency bands for a communication with one or more network entities, e.g., one or more user devices or one or more base stations, in the wireless communication system,
wherein the apparatus is to receive a transport block, TB, the TB being split into a plurality of code block groups, CBGs, each CBG comprising one or more code blocks, CBs, and being confined to one of the plurality of frequency bands,
wherein the apparatus is to provide or predict a regular feedback for each of the CBGs indicating a successful and/or a non-successful receipt of the CBG, e.g., a hybrid automatic repeat request, HARQ, feedback, and
wherein, in case an amount of interference on one or more of the frequency bands which is detectable at the receiver, e.g. an interference due to a hidden node problem, exceeds a certain threshold, the apparatus is to transmit an early feedback for one or more CBGs ahead of any regular feedback, the early feedback indicating for the one or more CBGs that a CBG or parts of a CBG are not received correctly or are predicted to be not decodable.

20. The apparatus of claim 19, wherein the apparatus is to determine the amount of interference on a frequency band based on measurements of certain channel occupancy metrics, e.g., a DMRS decorrelation, an RSSI or the like.

21. The apparatus of claim 19, wherein the interference is due to a hidden node issue.

22. The apparatus of claim 19, wherein the apparatus is to transmit the early feedback on one or more configured or pre-configured resources in one or more of the frequency bands, e.g., using respective indicator channels on the frequency bands.

23. The apparatus of claim 19, wherein the early feedback comprises one of the following:
a predicted HARQ feedback,
a prediction of how much additional redundancy is needed,
a compressed HARQ feedback,
an indication of the frequency band where the amount of interference exceeded the threshold,
a single bit indicting that the amount of interference exceeded the threshold on any one of the frequency bands.

24. The apparatus of claim 19, wherein one or more or all of the frequency bands are unlicensed subbands, and wherein
following a successful Listen-Before-Talk, LBT, for one or more unlicensed subbands, a communication is allowed during a certain transmission time, (COT) in an available unlicensed subband, or
following a failed Listen-Before-Talk, LBT, for one or more unlicensed subbands, a communication is not allowed in a non-available unlicensed subband, or
following a successful channel assessment procedure, e.g. RTS/CTS, for one or more unlicensed subbands, a communication is allowed during a certain transmission time, (COT) in an available unlicensed subband, or
following a failed channel assessment procedure, e.g. RTS/CTS, for one or more unlicensed subbands, a communication is not allowed in a non-available unlicensed subband.

25. An apparatus for a wireless communication system,
wherein the apparatus is to use a plurality of frequency bands for a communication with one or more network entities, e.g., one or more user devices or one or more base stations, in the wireless communication system,
wherein the apparatus is to transmit to a receiver a transport block, TB, the TB being split into a plurality of code block groups, CBGs, each CBG comprising one or more code blocks, CBs, and being confined to one of the plurality of frequency bands,
wherein the apparatus is to receive from the receiver
a regular feedback or a regular predicted feedback for each of the CBGs indicating a successful and/or a non-successful receipt of the CBG, e.g., a hybrid automatic repeat request, HARQ, feedback, and
an early feedback ahead of any regular feedback for one or more CBGs on one or more of the frequency bands experiencing an amount of interference, exceeding a certain threshold, and
wherein, responsive to the early feedback, the apparatus is to transmit to the receiver a retransmission for the one or more CBGs on one or more frequency bands which are not affected by the interference.

26. The apparatus of claim 25, wherein the apparatus is to redistribute the resources on the one or more frequency bands which are not affected by the interference to one or more other receivers which are not affected by the interference.

27. The apparatus of claim 1, wherein
the apparatus comprises a user device, UE, wherein the UE comprises one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, and/or
the apparatus comprises a base station, BS, wherein the BS is implemented as mobile or immobile base station and comprises one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

28. A wireless communication system, comprising one or more user devices and one or more base station, wherein one or more of the user devices and/or one or more of the base stations comprise an apparatus of claim 1.

29. A method for providing feedback in a wireless communication system, the method comprising:
receiving, by a receiver, from one or more network entities, e.g., one or more user devices or one or more base stations, in the wireless communication system, a transport block, TB, using a plurality of frequency bands, the TB being split into a plurality of code block groups, CBCs, each CBG comprising one or more code blocks, CBs, and being confined to one of the plurality of frequency bands,
providing or predicting a feedback for each of the CBGs indicating one or more of a successful receipt of the CBG, a non-successful receipt of the CBG, no need for redundancy for the CBG and a need for some redundancy for the CBG, amount of additional redundancy needed, e.g., a hybrid automatic repeat request, HARQ, feedback,
compressing the feedbacks and/or the predicted feedbacks for each of the CBGs into a compressed feedback based on an interference pattern on one or more of the frequency bands which is detectable at the receiver and the one or more network entities, e.g. Listen-before-Talk, LBT, failure, and
transmitting to one or more of the network entities the compressed feedback.

30. A method for providing feedback in a wireless communication system, the method comprising:
receiving, by a receiver, a transport block, TB, using a plurality of frequency bands for a communication with one or more network entities, e.g., one or more user devices or base stations, in the wireless communication system, the TB being split into a plurality of code block groups, CBG, each CBG comprising one or more code blocks, CBs, and being confined to one of the plurality of frequency bands, and one or more of the plurality of CBGs spanning the TB duration,
providing a feedback or to predict a feedback for each of the CBGs indicating one or more of a successful receipt of the CBG, a non-successful receipt of the CBG, no need for redundancy for the CBG and a need for some redundancy for the CBG, amount of redundancy needed, e.g., a hybrid automatic repeat request, HARQ, feedback, and
in case of a failure of one or more of the frequency bands, reducing the feedback or the predicted feedbacks, e.g., a number of bits for the feedback or the predicted feedback, according to the failed frequency bands.

31. A method for providing feedback in a wireless communication system, the method comprising:
receiving, by a receiver, a transport block, TB, using a plurality of frequency bands for a communication with one or more network entities, e.g., one or more user devices or base stations, in the wireless communication system, the TB being split into a plurality of code block groups, CBG, each CBG comprising one or more code blocks, CBs, and being confined to one of the plurality of frequency bands, and one or more of the plurality of CBGs spanning the TB duration,
providing or predicting a regular feedback for each of the CBGs indicating a successful and/or a non-successful receipt of the CBG, e.g., a hybrid automatic repeat request, HARQ, feedback, and
in case an amount of interference on one or more of the frequency bands which is detectable at the receiver, e.g. an interference due to a hidden node problem, exceeds a certain threshold, transmitting an early feedback for one or more CBGs ahead of any regular feedback, the early feedback indicating for the one or more CBGs that a CBG or parts of a CBG are not received correctly or are predicted to be not decodable.

32. A method for providing feedback in a wireless communication system, the method comprising:
transmitting to a receiver a transport block, TB, using a plurality of frequency bands for a communication with one or more network entities, e.g., one or more user devices or base stations, in the wireless communication system, the TB being split into a plurality of code block groups, CBG, each CBG comprising one or more code blocks, CBs, and being confined to one of the plurality of frequency bands, and one or more of the plurality of CBGs spanning the TB duration,
receiving from the receiver a regular feedback or a regular predicted feedback for each of the CBGs indicating a successful and/or a non-successful receipt of the CBG, e.g., a hybrid automatic repeat request, HARQ, feedback, or an early feedback ahead of any regular feedback for one or more CBGs on one or more of the frequency bands experiencing an amount of interference, exceeding a certain threshold, and
responsive to the early feedback, transmitting to the receiver a retransmission for the one or more CBGs on one or more frequency bands which are not affected by the interference.

33. A non-transitory digital storage medium having a computer program stored thereon to perform the method of claim 29, when said computer program is run by a computer.
